(19) United States
(12) Patent Application Publication
(10) Pub. No.: US 2009/0021482 A1
(43) Pub. Date: Jan. 22, 2009

(54) Virtually multiple wheels and method of manipulating multifunction tool icons thereof

(76) Inventors: Ying-Chu Lee, Yunlin County (TW); Kuo-Wei Lee, Yunlin County (TW)

Correspondence Address: BACON & THOMAS, PLLC, 625 SLATERS LANE, FOURTH FLOOR, ALEXANDRIA, VA, 22314-1176, US

(21) Appl. No.: 12/219,175

(22) Filed: Jul. 17, 2008

(30) Foreign Application Priority Data
Jul. 20, 2007 (TW) 096126551
Sep. 21, 2007 (TW) 096135360
Feb. 19, 2008 (TW) 097105742

(51) Int. Cl. G06F 3/033

(52) U.S. Cl. 345/163

(57) ABSTRACT

Virtually multiple wheels are recognized as the multiple manipulation positions provided by a wheel for the scrolling by the finger. A sensor senses the manipulation position of the finger, and issues a corresponding auxiliary signal, empowering the wheel to have multiple manipulation modes, that is, each of the manipulation position is used as one virtual wheel.

Scrolling the wheel from the middle, from the left side, and from the right side are three preferred manipulation positions. A slight shift of the finger to the left or right is enough to manipulate multiple software functionalities.

A tool icon links multiple sets of software functionalities responded to the wheel message, and through the differentiation of the auxiliary signal corresponding to each set, which is the multifunction tool icon.

The manipulation of multiple multifunction tool icons by the single wheel of virtually multiple wheels is an improved manipulation method of computer software, where its manipulation interface is quite compact yet abundant in contents.

### BACKGROUND OF THE INVENTION

1. Field of the Invention

The single wheel of virtually multiple wheels of the present invention is an improved tool for the computer input, and the manipulation of the multifunction icon by it is an improved manipulation method for computer software.

2. Description of the Prior Art

In the personal computer environment, the use of the wheel to manipulate window applications in the prior art is the wheel mouse. Since the wheel has brought in great handiness, almost all the mice are provided with a wheel fitting. As the software functionality increases gradually, the opportunity to use the wheel gets more and more, and the single wheel of the mouse can't afford the demand. Some mice were equipped with a second wheel; unfortunately, the use is not handy at all, so that the second wheel fails to get popularity, and there is much room for further improvement. Some software are linked with some keys of the keyboard, by means of pressing a key and scrolling the wheel simultaneously, a single wheel is empowered to implement multiple uses. On the other hand, the drawback is the exclusive occupancy of one hand only on pressing the key, which does raise the load of the user while substantially reduce the handiness and smoothness of the use of the wheel.

The advancement of software functionality considerably boosts a surge of tool icons, taking up more screen space, which makes the user interfaces in a cumbersome jumble; therefore, the efficient use of a single wheel to ease complicated tool icons is no doubt a problem to settle in a hurry.

### SUMMARY OF THE INVENTION

The objective of the present invention is to solve the two problems: the inefficient usage of the mouse wheel during the manipulation of the window applications, and the cumbersome jumble of the user interfaces due to a surge of tool icons. The present invention is made up of hardware and software, where the hardware part offers a method that enables a single wheel of multiple uses, and again offers a single wheel device featuring virtually multiple wheels that is available to install in the mouse, keyboard and notebook computers.

In the software part, the present invention is provided with a multifunction tool icon, and further to provide a method of manipulating the multifunction tool icon by the single wheel device of virtually multiple wheels.

In a preferred embodiment of the hardware of the present invention, the hardware adopts a wheel mouse and a finger sensing device. The wheel provides multiple manipulation positions for the finger scrolling the wheel; for instance, scrolling from the middle of the wheel, from the right side of the wheel, from the left side of the wheel. The sensing device is used for sensing one of the multiple manipulation positions that the finger is located.

Once the user scrolls the wheel at each of the multiple manipulation positions, the sensing device senses the position manipulated by the finger, issuing an auxiliary signal to distinguish between different manipulation positions. Scrolling the wheel will also issue a wheel message at the same time.

Scrolling at a different manipulation position will issue a different auxiliary signal, and once the software receives the wheel message, it will react with a different response subject to a different auxiliary signal. Therefore, the user is able to manipulate a different software functionality by changing the manipulation position of the finger with ease. Since the wheel is provided with multiple manipulation positions, it hence has multiple manipulation modes; that is, each manipulation position is used as a virtual wheel.

Finger sensing device is a matured technique which is quite popular in the industry. By combining it with the conception of the multiple manipulation positions, enabling a single wheel operated as multiple wheels, where such a wheel developed by the above method is easy and practical in manipulation. Especially the manipulation positions for scrolling are at the left side, the middle, and the right side, the user simply shifts his/her finger a bit left or right which brings about a prompt switch among the three manipulation positions. By comparing this manipulation mode with that of the prior art, there are three important traits:
1. Accommodating more software functionalities within the same area—a single wheel contains the software functionalities of multiple wheels.
2. Empowering the user to issue more manipulation commands within the same time frame—scrolling such a wheel enables a prompt and successive issuing of multiple equivalent commands where the selection of a different command only by shifting the finger a bit left or right.
3. More comfortable in manipulation—only finger tip motions, the breadth is quite small.

The above three traits will advance such a wheel with great perspective in the future, not only in the domain of personal computer, but even smaller computer devices, such as cell phone, digital camera, remote control and the like, which are potential to have a more handy and efficient way of manipulation.

For such a wheel, the finger sensing device could be a contact type or a non-contact type. Since non-contact type has no contact target, the left side, middle and the right side of such wheel are made into different color, for guiding the finger of the user to the manipulated position, and signaling the user that the three colors means three independent wheels. Scrolling at each color means to manipulate different software functionality.

In the software part, the multifunctional tool icon of the present invention is a tool icon that links multiple sets of software functionalities responded to the wheel message, and each set of the functionalities is differentiated from one another subject to a different auxiliary signal. In the exemplified embodiment of the present invention, the three sets (six kinds) software functionalities linked by a tool icon are “rotating 90 degrees”, “change of page” and “contracting and enlarging”, each set of the functionalities is used to respond the up scrolling and down scrolling of such a wheel.

The “rotating 90 degrees” is categorized into “clockwise rotation” and “counterclockwise rotation”; the “change of page” into “previous one” and “next one”; the “contracting and enlarging” into “enlargement” and “contraction”, and there is six kinds in total. The “rotating 90 degrees” is linked by shift signal as its auxiliary signal, and “contracting and enlarging” is linked by ctrl signal as its auxiliary signal.

As the user places the cursor over the tool icon and scrolls the wheel at different manipulation position, the software functionality responded will be subject to the corresponding auxiliary signal. For instance, the “rotating 90 degrees” responds to the left side scrolling, the “change of page” responds to the middle scrolling, and the “contracting and enlarging” responds to the right side scrolling.

In the work area of a tool icon, the linkage of six software functionalities will vastly simplify the user interface, and the tool icon can be dynamically transformed to the icon of a user executable software functionality when changing the manipulation position by the finger, which will not confuse the user.

Manipulating multiple multifunction tool icons by such a wheel is an improved manipulation method of computer software, which features a compact user interface, copious manipulation functionalities and great manipulation efficiency.

### BRIEF DESCRIPTION OF THE DRAWINGS

The aforementioned of the present invention and other objects, traits, advantages and exemplified embodiment will be clearly comprehended by referring to the following detailed description in conjunction with the accompanying drawings.

FIG. 1 shows a mouse with finger sensing interfaces;

FIG. 2a-2c shows the three manipulation positions for the scrolling of the wheel by the finger for the wheel mouse shown in FIG. 1;

FIG. 3 shows the wheel mouse having four sensing interfaces disclosed in another exemplified embodiment of the present invention;

FIG. 4 shows the single wheel device of virtually multiple wheels of the present invention installed in a notebook computer; and

FIG. 5a-5c shows the manipulation of the multifunction tool icons by the single wheel of virtually multiple wheels of the present invention.

### DETAILED DESCRIPTION OF THE INVENTION

The technical contents of the preferred embodiment of the present invention are categorized into two parts: hardware and software. The hardware part adopts a wheel mouse and a finger sensing device. The wheel is provided with multiple manipulation positions for the finger in scrolling the wheel; for instance, scrolling from the middle of the wheel, from the right side of the wheel, from the left side of the wheel. The sensing device is used for sensing one of the multiple manipulation positions that the finger is located.

Once the user scrolls the wheel at each of the multiple manipulation positions, the sensing device senses the position manipulated by the finger, issuing an auxiliary signal to distinguish between different manipulation positions. Scrolling the wheel will also issue a wheel message at the same time.

Scrolling at a different manipulation position will issue a different auxiliary signal, and once the software receives the wheel message, it will react with a different response subject to a different auxiliary signal. Therefore, the user is able to manipulate a different software functionality by changing the manipulation position of the finger with ease. Since the wheel is provided with multiple manipulation positions, it hence has multiple manipulation modes; that is, each manipulation position is used as a virtual wheel.

The manipulation position can be arbitrarily assigned. Assigning the manipulation position means building up a connection protocol between the user and the device, so that it is not only to ease the implementation for the user, but to differentiate correctly by the sensing device. Scrolling from the middle of the wheel (“middle scrolling” for short below), from the left side of the wheel (“left scrolling” for short below) and from the right side of the wheel (“right scrolling” for short below) are three manipulation positions that compliant to the above protocol, which are also preferred manipulation positions.

To make the aforesaid objects of the present invention, traits, and advantages to be clearly comprehended, the passage in the following cites the preferred exemplified embodiment in conjunction with the accompanying drawings for the detailed description. In the present embodiment, the wheel mouse with the three manipulation positions: left scrolling, middle scrolling and right scrolling is exemplified, and the mouse can be a wired or wireless mouse.

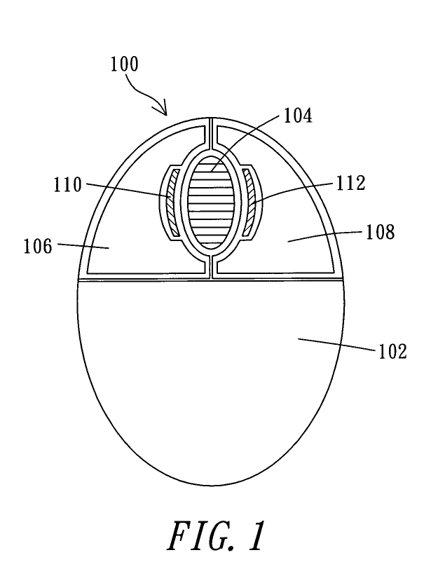

Referring to FIG. 1, FIG. 1 shows a mouse with the contact type of sensing interfaces. The wheel mouse 100 comprises a body 102, a wheel 104, buttons 106 and 108, sensing interfaces 110 and 112 of the contact sensor. Those same as the prior art are that the wheel 104 and the buttons 106, 108 are set up on one side of the body 102, and the wheel 104 is set up in between the buttons 106 and 108. The sensing interfaces 110 and 112 of contact sensor are set up at the left and right sides of the wheel 104 respectively and between the wheel 104 and the button 106 and the wheel 104 and the button 108 respectively. In the present embodiment, the sensing interface of the contact sensor can be a copper electrode

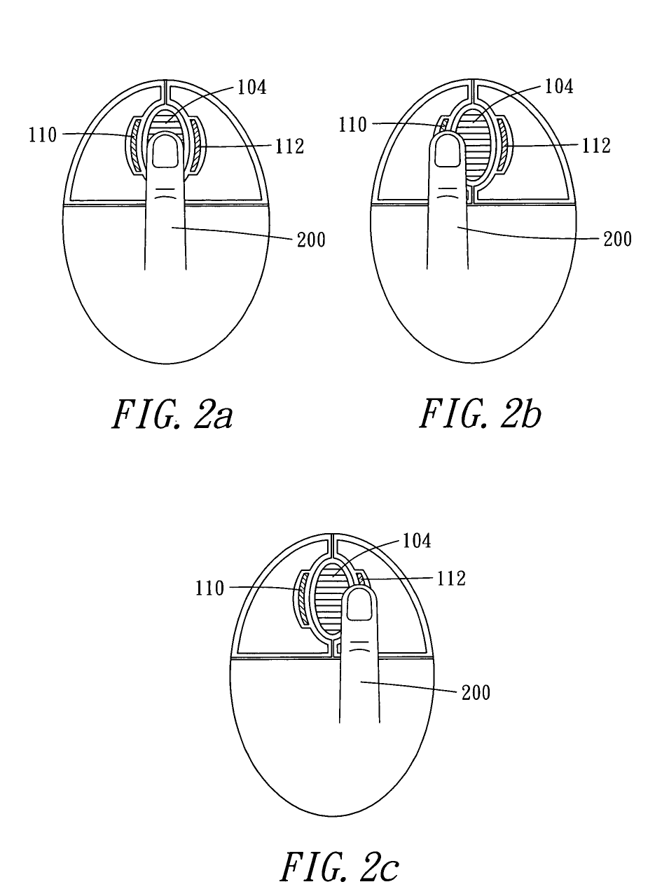

FIGS. 2a-2c shows the three manipulation positions of the scrolling of the wheel by the finger for the wheel mouse shown in FIG. 1. FIG. 2a shows the scrolling of the wheel 104 from its middle. FIG. 2b shows the scrolling of the wheel 104 from its left side. FIG. 2c shows the scrolling of the wheel 104 from its right side. The wheel 104 protrudes the top side of the body 102 by an adequate height and with an adequate width. FIG. 2a shows when the user scrolls the wheel 104 from its middle, the finger 200 will not touch the sensing interfaces 110 and 112, and the sensor won't issue an auxiliary signal under this circumstance; therefore, the mouse only sends a wheel message without an auxiliary signal.

In FIG. 2b, once the user scrolls the wheel 104 from its left side, the finger 200 will touch the sensing interface 110, which enables the sensor to issue a first auxiliary signal. Moreover, the scrolling of the wheel will also issue a wheel message.

In FIG. 2c, once the user scrolls the wheel 104 from its right side, the finger 200 will touch the sensing interface 112, which enables the sensor to issue a second auxiliary signal. Moreover, the scrolling of the wheel will also issue a wheel message.

Therefore, the scrolling of the wheel at the different manipulation position and together with the support of the auxiliary signal issued by the sensor, the single wheel is then used as multiple wheels.

If the wheel is enlarged a bit, the sensing interfaces 110, 112 are possible to be installed at the left and right sides of the wheel 104, which makes the left scrolling and the right scrolling smoother, but it is important to avoid the possibility of accidentally touch during the middle scrolling.

The sensor can also be a non-contact type, for instance, the photo-interrupted or capacitor types of sensors. The sensing interfaces shown in FIG. 1 are arranged to be the sensing areas, and the finger is detected once it just enters into those areas and an auxiliary signal is then generated.

Once the non-contact sensor is in use, the left side, the middle, and the right side can be made into three different colors, and let the user scroll the wheel at different color area, which clearly guides the finger to the correct sensing positions.

The spirit of the present invention lies in each manipulation position on the wheel is taken as a virtual wheel; therefore, more wheels demand means planning more manipulation positions and sensor device, to get more virtual wheels. The following gives an example:

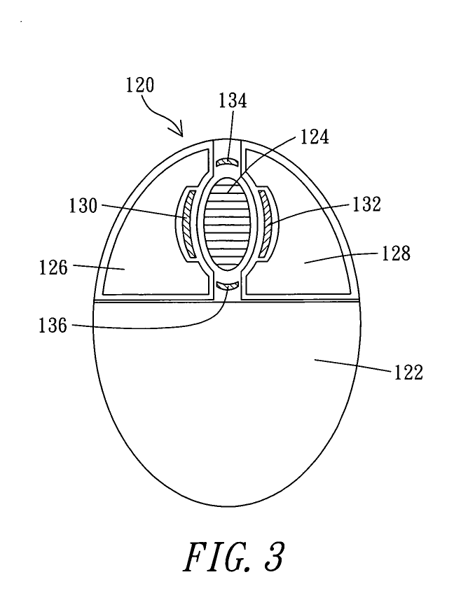

FIG. 3 shows the wheel mouse having more manipulation positions disclosed in another exemplified embodiment of the present invention. Mouse 120 comprises a body 122, a wheel 124, buttons 126 and 128. Those same as the prior art are that the wheel 124 and the buttons 126, 128 are set up on one side of the body 122, and the wheel 124 is set up in between the buttons 126 and 128. The sensing interfaces 130 and 132 of the sensor are set up at the left and right sides of the wheel 124 respectively and between the wheel 124 and the button 126 and the wheel 124 and the button 128 respectively. The sensing interfaces 134 and 136 of the sensor are set up at the top and bottom of the wheel 124. In this embodiment, if the sensor is a contact type, the sensor interface can be the copper electrode; if it is non-contact type, the sensing interfaces are arranged to be the sensing areas. In this embodiment, the two sensing interfaces: 134 and 136 can offer the mouse 120 two new manipulation positions; scrolling down from top of the middle of the wheel; scrolling up from bottom of the middle of the wheel. The manipulation positions provided by the sensing interfaces 134, 136 at the top and bottom sides of the wheel 124, can be predefined; for instance, as the acceleration of the scrolling up and scrolling down of the wheel on the computer screen.

The single wheel of virtually multiple wheels (multi-wheels for short) of the present invention is able to set up in the mouse, keyboard and notebook computer.

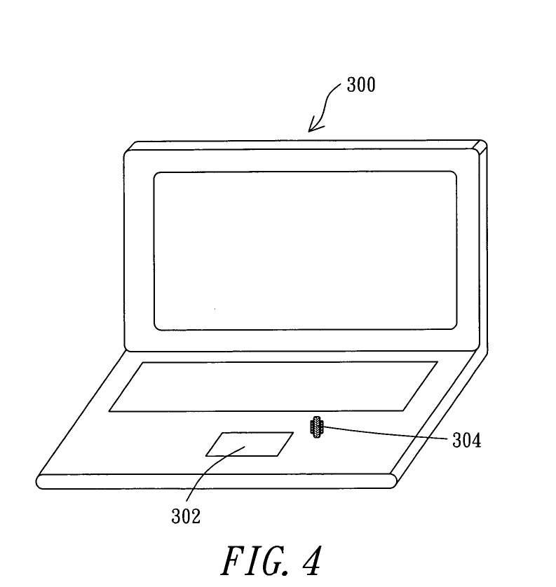

FIG. 4 shows the multi-wheels of the present invention installed in a notebook computer, which is located at the same platform as the keyboard does. Notebook computer 300 already has touch panel 302 for moving the cursor, where the multi-wheels device 304 is set up next to the touch panel, which makes the notebook computer 300 become a fully loaded product, and makes the users of the notebook computer substantially reduce the rely on mouse.

To the existed software, the auxiliary signals of the sensor are new and unrecognized signals, so that the existed software provides no response. In other words, as the existed software is manipulated by the multi-wheels, the scrolling of the wheel at each of different manipulation position will be responded with the same software functionality manipulated by the wheel (a software functionality manipulated by the wheel is called “wheel functionality” for short below). Some of the software is provided with a second wheel functionality by pressing the ctrl key and scrolling the wheel, while a third wheel functionality by pressing the shift key and scrolling the wheel. For instance, in Microsoft Word, press the ctrl key and scroll the wheel can contract or enlarge the display ratio of the screen; in the Explorer software, press ctrl key and scroll the wheel can change the size of the letterform, press shift key and scrolling the wheel can change to previous page or next page. Others such as Microsoft Power Point, Acrobat also support the software feature—press ctrl key and scroll the wheel in their software. Suppose the above software are intended to be manipulated by the multi-wheels, an approach is done by transforming the auxiliary signal of “right scrolling” into the ctrl signal and sending out, which is then able to use “right scrolling” to manipulate the wheel functionality linked by the ctrl key in the above software. Take the auxiliary signal of the “left scrolling” to transform into the shift signal and sending out, which is able to use “left scrolling” to manipulate the wheel functionality linked by the shift key in the above software.

Reversely, any software intends to cooperate with the multi-wheels of the present invention, where the way is to link the second wheel functionality to the ctrl key and to link the third wheel functionality to the shift key, and the second and the third wheel functionalities are ready to take the manipulation of the “right scrolling” and the “left scrolling”.

Another embodiment of the present invention is an exemplified embodiment that is made of the aforesaid embodiment together with software application.

An example of graphic display software is given to describe the implementation of the multifunction tool icon, and how to manipulate the software having multifunction icon through the multi-wheels of the present invention.

A graphic display software package offers a tool icon, and provides three sets of software functionalities responded to the wheel message, which are “rotating 90 degrees”, “change of page” and “contracting and enlarging”, where the functionalities of each set is used to respond up scrolling and down scrolling. Same as the aforesaid, where “rotating 90 degrees” and “contracting and enlarging” are linked to the shift key and the ctrl key respectively.

As the graphic display software displays a picture in the window, if the user places the cursor over the tool icon, followed by manipulating the wheel with the middle scrolling, left scrolling and right scrolling, then the graphic display software responds as follows:
Left scrolling up, the picture rotates 90 degrees counterclockwise
Left scrolling down, the picture rotates 90 degrees clockwise
Middle scrolling up, the picture is replaced by the previous one
Middle scrolling down, the picture is replaced by the next one
Right scrolling up, the picture is contracted
Right scrolling down, the picture is enlarged

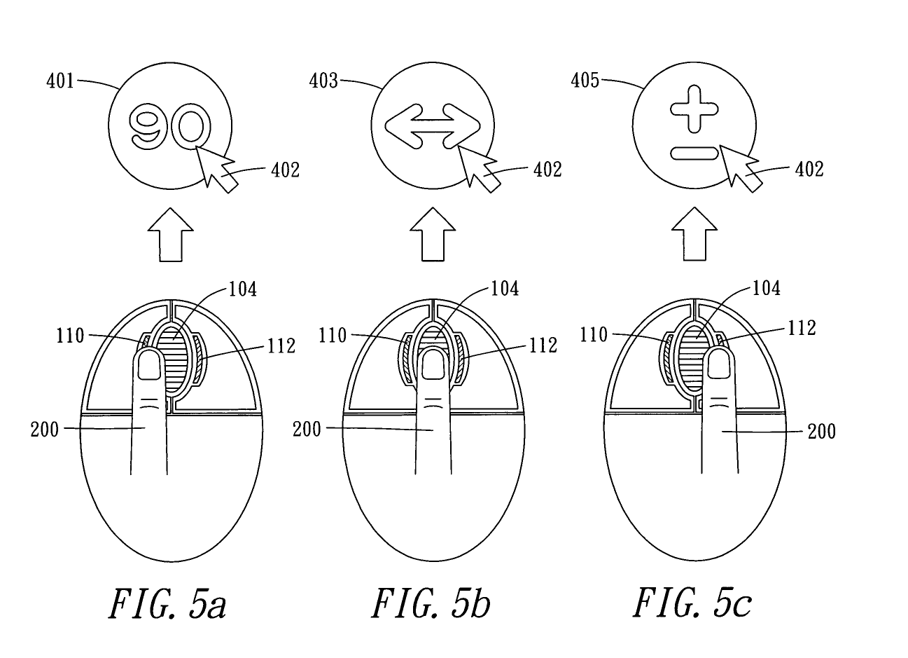

FIGS. 5a-5c show the manipulation of the multifunction tool icon by the single wheel of virtually multiple wheels of the present invention. It always confuses a user to use one tool icon to represent multiple software functionalities, and the present embodiment offers an approach of improvement herewith:

In FIG. 5a, as the finger 200 of a user touches the wheel 104 and the sensing interface 110, the sensor senses the finger at a location of the left scrolling where the wheel has not been scrolled at the moment, and the sensor sends out a first auxiliary signal, followed by the graphic display software immediately transforming the tool icon into the tool icon 401 that represents “rotating”. As a consequence, the wheel 104 rolls up—the picture rotates 90 degrees counterclockwise while the wheel 104 rolls down—the picture rotates 90 degrees clockwise.

In FIG. 5b, during a user's finger 200 merely touching the wheel 104, where the finger 200 is placed at the middle scrolling position, the sensor won't send any auxiliary signal, and the graphic display software immediately transforms the tool icon into the tool icon 403 that represents “change of page”. At this moment, the wheel 104 rolls up, and the picture is replaced by the previous one, while the wheel 104 rolls down, and the picture is replaced by the next one.

In FIG. 5c, once the finger 200 of a user contacts the wheel 104 and the sensing interface 102, the sensor senses the finger at the location of the right scrolling where the wheel has not been scrolled at the moment, and the sensor sends out a second auxiliary signal, followed by the graphic display software immediately transforming the tool icon into the tool icon 405 that represents “contracting and enlarging”. As a consequence, the wheel 104 rolls up—the picture is contracted while the wheel 104 rolls down—the picture is enlarged.

A multifunction tool icon links not only multiple sets of software functionalities, but links multiple tool icons that represent the multiple set of software functionalities. As the cursor is placed over the tool icon, a corresponding tool icon will be shown, subject to the manipulation position of the finger. For the situation of not placing the cursor over the tool icon, the multifunction tool icon can display each tool icon by automatic changing under a preset rules, to exhibit each of its software functionalities. For instance, three pictures are changing in order by a one second interval.

This invention can also be applied to other software. For instance, offering a multifunction tool icon in an office software package, where the linked three sets of software functionalities are “contracting and enlarging the letterform”, “changing line width of paragraph” and “changing document display ratio”, and each set of the functionalities are responded to up scrolling and down scrolling of the wheel. Hence, once the user places the cursor over the tool icon, and through the change of the scrolling position of the wheel by the finger, the user can then effectively manipulate the six functionalities of the office package.

In another example of a media playing software, a tool icon is provided to link three sets of functionalities, which are “previous one or next one”, “sound volume amplified or diminished” and “fast forward or back forward”, where each set of the functionalities are responded to up scrolling and down scrolling of the wheel. Hence, once the user places the cursor over the tool icon, and through the change of the scrolling position of the wheel by the finger, the user can then effectively manipulate the six functionalities of the media playing software.

In the other network browsing software, a tool icon is provided to link three sets of functionalities, which are “previous one or next one”, “contracting and enlarging the letterform” and “expediting up scrolling or down scrolling webpage”, where each set of the functionalities are responding to up scrolling and down scrolling of the wheel. Hence, once the user places the cursor over the tool icon, and through the change of the finger at the scrolling position of the wheel, the user can then effectively manipulate the six functionalities of the network browsing package.

Accordingly, bring the multi-wheels of hardware together with the dynamically presented multifunction tool icons of software, the user can place the cursor over the tool icon and no more move the mouse. Through the slight shift of the finger followed by scrolling the wheel, six (three sets) software functionalities can be promptly and instantly manipulated.

Furthermore, a software package that is capable of integrating the related functionalities into more multifunction tool icons, for instance, in a graphic display software package, there are three multifunction tool icons: A, B, and C:
Multifunction tool icon A: comprises three sets of functionalities: rotation, change of page, and contraction and enlargement
Multifunction tool icon B: comprises three sets of functionalities: color, brightness, and clearness
Multifunction tool icon C: comprises three sets of functionalities: change of position for pictures, transition of layout, adding or removing of a picture.

In a display screen, three multifunction tool icons contain the above 9 sets of functionalities. Placing the cursor over an icon, it is available to use the multi-wheels to manipulate those three sets of functionalities.

In a display screen to manipulate the 9 sets of functionalities, if they are done by clicking the left button of the mouse as usual, it takes eighteen icons in the display screen and frequent moves of the mouse to locate the cursor over the different icons and followed by a clicking.

Therefore, the manipulation architecture made of the multi-wheels and the multifunction tool icons is valuable in use.

The multi-wheels and the multifunction tool icons of the present invention belong to different technical fields. Without the support of the multi-wheels, the multifunction tool icon means not much. The multi-wheels can be used alone, but it can be powerful by the support of the multifunction tool icon, which brings about a compact yet abundant user interface.

Although the creation background of the present invention is personal computer, the multi-wheels of the present invention is easy to fit in the smaller computer system, for instance, a cell phone:

The approach as follows is to make a wheel into four virtual wheels (referring to FIG. 3 for the approach), where the fourth virtual wheel is characterized with the top of the middle scrolling:
1. With the left scrolling to select one item from its first layer data items (information, call log, phone list, setting, file manager, etc.). Say to select “call log” in this step.
2. With the middle scrolling to select one item from its second layer data items (received incoming calls, non-received incoming calls, dialed incoming calls, etc.). Say to select “non-received incoming calls” in this step.
3. With the right scrolling to select one item from its third layer data items (non-received incoming call 1, non-received incoming call 2, non-received incoming call 3, etc.). Say to select “non-received incoming call 2” in this step.
4. With the top of the middle scrolling to select one item from its fourth layer data items (dial out, delete, save, etc.). Say to select “delete” in this step.

Through the design of the multi-wheels, it is available to make use of the different scrolling position of the wheel in transiting among the layers, instead of the need of “entering” in and “withdrawing” from a layer like the traditional buttons; make use of the up scrolling and down scrolling of the wheel to select the data item within a layer, which is more handy than the selection by up and down buttons.

Another example for the multi-wheels to applied in the TV remote control:
With the middle scrolling to select the previous channel and the next channel
With the right scrolling to adjust the sound volume
With the left scrolling to select the channel (10, 20, 30, etc.) in a hopping way

The other example for the multi-wheels to applied in the air conditioner control:
With the middle scrolling to increase or decrease temperature
With the right scrolling to adjust the wind volume
With the left scrolling to increase or decrease the set time

In these small computer based devices, the wheel is viable to expand into a sphere or an ellipse to boost the aesthetic perception and practicability.

While the present invention has been disclosed in the aforesaid with reference to the exemplified embodiments thereof, the present invention is not intended to be limited by the embodiments. Those skilled in the art know that any equivalent embodiments or modifications without departing from the spirit and scope of the present invention are therefore intended to be embraced. Thus, the scope of the protection of the present invention is to be determined by the broadest permissible interpretation of the following claims.

What is claimed is:

1. A method of enabling a single wheel used as multiple wheels, which is called virtually multiple wheels, comprising:
a wheel, offered for the manipulation of the computer, where said wheel is provided with a plurality of manipulation positions for the scrolling by a finger;
a sensing device, for sensing the finger of a user at one of the manipulation positions; and
an auxiliary signal, for issuing subject to the sensed manipulation position;
through said auxiliary signal corresponding to the sensed manipulation position, to enable said wheel to have a plurality of manipulation modes.

2. A method of enabling a single wheel used as multiple wheels as in claim 1, wherein the manipulation positions contains two out of the following three manipulation positions:
Scrolling from the middle of said wheel
Scrolling from the left of said wheel
Scrolling from the right of said wheel

3. A method of enabling a single wheel used as multiple wheels as in claim 1, wherein the virtually multiple wheels of the multiple manipulation positions is set up in a mouse.

4. A method of enabling a single wheel used as multiple wheels as in claim 1, wherein the virtually multiple wheels of the multiple manipulation positions is set up in a computer keyboard.

5. A method of enabling a single wheel used as multiple wheels as in claim 1, wherein the virtually multiple wheels of the multiple manipulation positions is set up in a notebook computer.

6. A wheel device of multiple manipulation positions, set up in a platform, comprising:
a wheel, offered for the manipulation of the computer, embedded in the platform;
a sensing device, where said sensing device has at least a sensing interface located at one side of the wheel; and
as the user scrolls said wheel by a finger, said wheel featuring different manipulation modes, subject to the sensing or non-sensing of the finger by said sensing interface.

7. A wheel device as in claim 6 wherein the sensing interface is a contact sensing interface.

8. A wheel device as in claim 6 wherein the sensing interface is a copper electrode.

9. A wheel device as in claim 6 which is set up in a cell phone.

10. A method of manipulating multifunction tool icon by a virtually multiple wheels, comprising:
a computer apparatus, displayed a multifunction tool icon in the screen, where the multifunction tool icon links multiple sets of software functionalities responding to the wheel message, each set of software functionalities responded to up scrolling or down scrolling of the wheel, where one set of software functionalities associates with an auxiliary signal;
offering a wheel device and a sensing device, where said wheel device provides a plurality of manipulation positions for the scrolling by the finger, and once the sensing device sensing the finger at one of the manipulation position, said auxiliary signal being sent;
as the user selecting the multifunction tool icon, scrolling said wheel device, by sending said auxiliary signal, the aforesaid set of software functionalities associated with said auxiliary signal being executed.
